(19) United States
(12) Patent Application Publication
(10) Pub. No.: US 2018/0027799 A1
(43) Pub. Date: Feb. 1, 2018

(54) TREE STAND

(71) Applicant: DDI, Inc., Dubuque, IA (US)

(72) Inventor: Andrae T. D'Acquisto, Bellevue, IA (US)

(21) Appl. No.: 15/662,244

(22) Filed: Jul. 27, 2017

Related U.S. Application Data
(60) Provisional application No. 62/367,172, filed on Jul. 27, 2016.

(51) Int. Cl. A01M 31/00

(52) U.S. Cl. CPC A01M 31/00; A47C 1/146

(57) ABSTRACT

A tree stand may include a platform having a tree gripping portion, a support extension extending from the platform and an imperforate strap connected to the support extension so as to wrap about a tree.

### CROSS REFERENCE TO RELATED APPLICATION

The present application is a non-provisional application claiming priority under 35 USC 119 from co-pending U.S. Provisional Patent Application 62/367,172 filed on Jul. 27, 2016 by Andre T. D'Acquisto and entitled TREE STAND, the full disclosure of which is hereby incorporated by reference.

### BACKGROUND

Tree stands are commonly used during hunting and wildlife observation. Such tree stands generally include a platform supported against the trunk of a tree.

### BRIEF DESCRIPTION OF THE DRAWINGS

FIG. 1 is a perspective view of an example tree stand mounted to a tree.

FIG. 2 is a top view of an example support extension of the tree stand of FIG. 1.

FIG. 3 is an end view of the example support extension of FIG. 2.

FIG. 4 is a first side view of an example arm of the example support extension of FIG. 2.

FIG. 5 is a top view of the example arm of 4.

FIG. 6 is a second side view of the example arm of FIG. 4.

FIG. 7 is a fragmentary perspective view of an end portion of the example arm of FIG. 4.

FIG. 8 is a top view of an example cross brace of the support extension of FIG. 2.

FIG. 9 is an end view of the example cross brace of FIG. 8.

FIG. 10 is a fragmentary perspective view of an example imperforate strap of the tree stand of FIG. 1.

FIG. 11 is a top view of the example imperforate strap of FIG. 10.

FIG. 12 is a side view of the example imperforate strap of FIG. 10.

FIG. 13 is a sectional view of a portion of the example strap of FIG. 11.

FIG. 14 is a perspective view of an example 1^{st} connector of the example tree stand of FIG. 1.

FIG. 15 is a first side view of the example connector of FIG. 14.

FIG. 16 is a second side view of the example connector of FIG. 14.

FIG. 17 is a top view of the example connector of FIG. 14.

FIG. 18 is a first side view of a second connector of the example tree stand of FIG. 1.

FIG. 19 is a second side view of the second connector.

FIG. 20 is a top view of the example 2^{nd} connector.

FIG. 21 is a sectional view of a portion of the tree stand of FIG. 1 illustrating the example 1^{st} connector in an unlocked or open state.

FIG. 22 is a sectional view of a portion of the tree stand of FIG. 1 illustrating the example 1^{st} connector in a locked state.

FIG. 23 is a fragmentary perspective view of a portion of the tree stand of FIG. 1.

FIGS. 24-27 are perspective views illustrating the example tree stand of FIG. 1 in different stages of deployment.

### DETAILED DESCRIPTION OF EXAMPLES

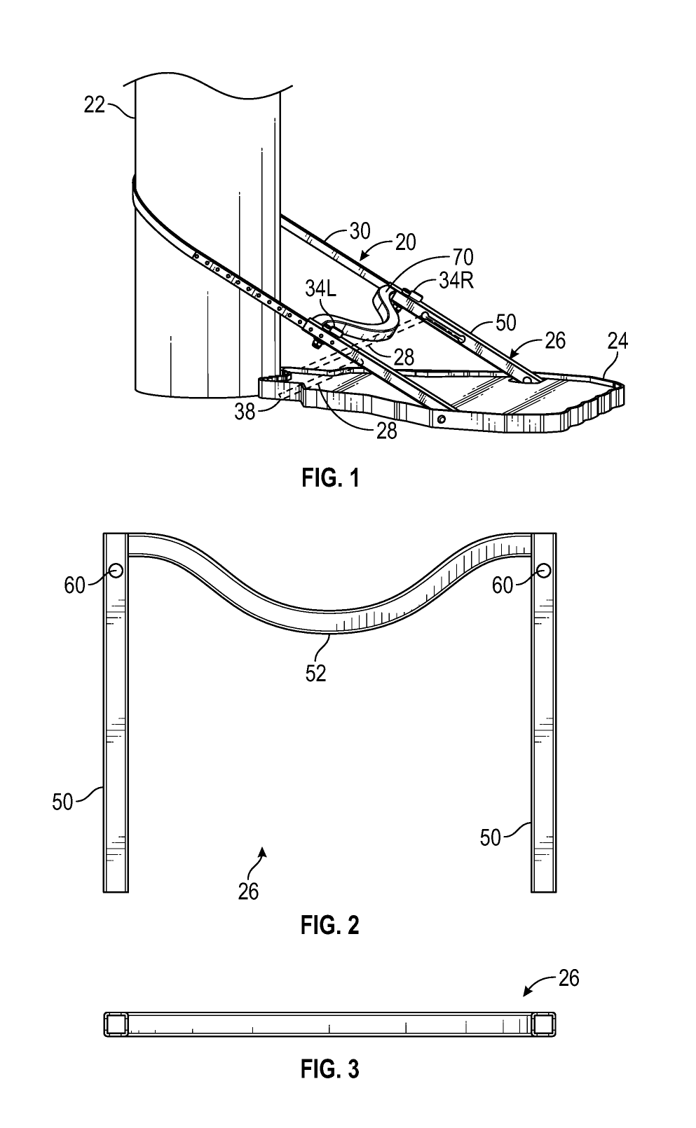

FIG. 1 is a perspective view illustrating an example tree stand 20 is mounted to a trunk of an example tree 22. Tree stand 20 has a construction that facilitates the use of a metal or other flexible strap to wrap around the tree 22, wherein the strap of the tree stand 20 has an enhanced durability and wear. As will be described hereafter, tree stand 20 releasably connects its platform to the strap without perforations or openings through the strap. As a result, the strap has enhanced durability.

For purposes of this disclosure, the term “imperforate” with respect to the strap means that the strap lacks any perforations, apertures or openings that completely extend through the thickness of the strap and that are completely surrounded by the material of the strap. For example, in imperforate strap may comprise a strap that is solid throughout. An “imperforate strap” may comprise an imperforate band, having a uniform width along a majority, if not all of its length, wherein the band lacks notches or cutouts along the edges, but wherein additional structures, such as protuberances, may be welded, bonded, adhered otherwise formed on the face of the imperforate band. An “imperforate strap” may comprise notches or cutouts extending into an edge of the strap. An “imperforate strap” may comprise a band having aperture openings extending completely through the thickness of the band and which are completely surrounded by the material of the band, wherein the strap further comprises structures that fill the apertures in the band such that completed strap is imperforate.

As shown by FIG. 1, tree stand 20 comprises platform 24, support extension 26, struts 28 (transparently shown in broken lines), imperforate strap 30 and connectors 34. Platform 24 comprises a panel or other rigid support upon which a person may stand or sit. In one implementation, platform 24 comprises a web or a perforated member. In other implementations, platform 24 may be solid. Platform 24 comprises a tree engaging portion 38 which abuts against and contacts the side of tree 22. In one implementation, the tree engaging portion 30 comprises a claw-like structure or tree gripping structure.

Support extension 26 comprises a bracket-like structure extending from platform 24 between platform 24 and imperforate strap 30. Support extension 26 is rigid. In the example illustrated, support extension 26 is pivotally connected to platform 24 at one end and releasably connected to strap 30 at the other end. Support extension 26 may have a variety of different sizes, shapes and configurations.

FIGS. 1-3 illustrate one particular example of support extension 26. In the example illustrated, support extension 26 comprises a pair of arms 50 spaced apart and interconnected by a cross brace 52.

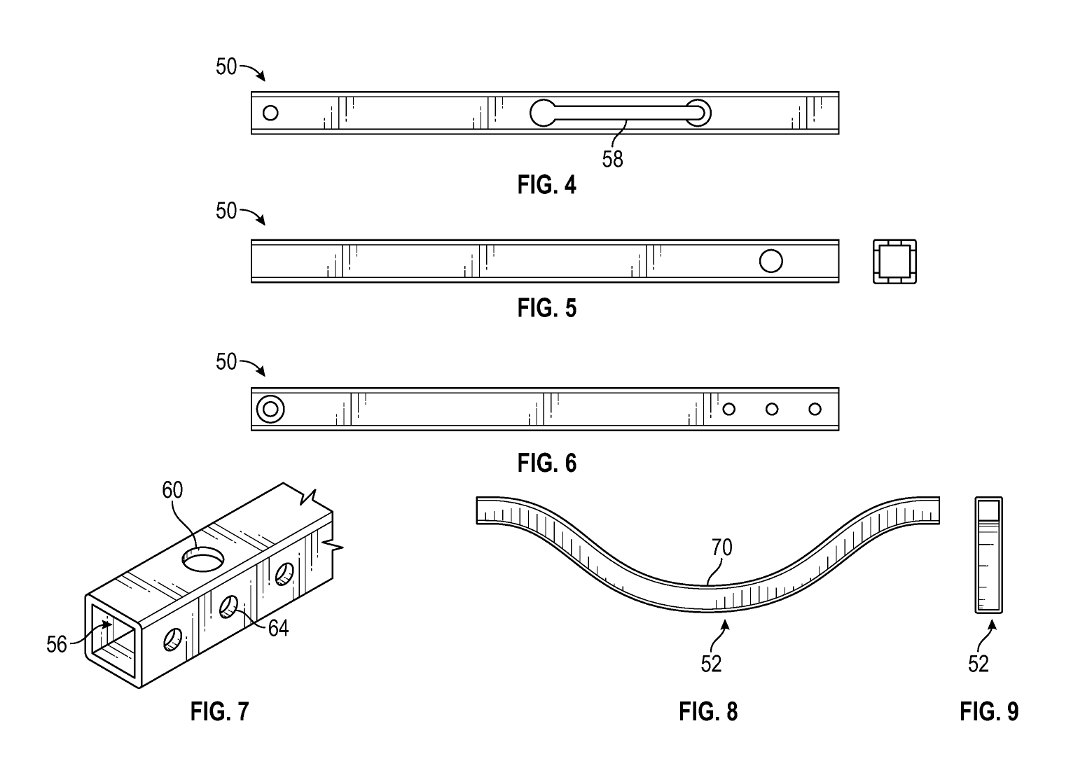

FIGS. 4-7 illustrate one of arms 50 in more detail. As shown by such figures, each arm 50 comprises an elongate square tubular member having an interior 56 sized and shaped to receive an end portion of strap 30. Each arm 50 further comprises multiple apertures including slot 58, cam opening 60 and a series of spaced detents 64. Slot 58 can extend along an interface of each of arms 50 and facilitates connection of a corresponding strut 28 to arm 50. In the example illustrated, each strut 28 has a bolt received within slot 58, wherein the positioning of strut 28 at either end of slot 58 may be secured by tightening a not or head and wherein loosening of another head facilitates sliding of strut 28 within slot 58 to facilitate pivoting of arms 50 and strut 28 towards platform 24 such that arms 50 and struts 28 are more parallel to one another for compact storage and transport. For use, struts 28 may be slid within slot 58 to the more extended position shown in FIG. 1 and tightened in the position shown.

Cam opening 60 extends through the tubular structure of each of arms 50. Opening 60 receives a portion of one of connectors 34. In the example illustrated, cam opening 60 comprises a circular bore extending through a top face of the tubular structure of arm 50, guiding rotation of the receive connector 34. In other implementations, depending upon the configuration of connector 34, cam opening 60 may have other sizes or shapes or may be omitted.

Detents 64 extend along an interface of each of arms 50. In the example illustrated, detents 64 comprise a series of spaced apertures or holes extending completely through the inner wall of the tubular structure of arm 50. As will be described hereafter, each of detents 64 is sized to receive a corresponding protuberance extending from strap 30. In other implementations, detents 64 may comprise cavities or pieces that only partially extend through the inner wall of the tubular structure of arm 50. For example, detents 64 may comprise cavities, craters, grooves, serrations or the like. In one implementation, detents 64 have a center to center pitch that matches the center to center pitch of protuberances extending from strap 30. In one implementation, detents 64 have a center to center pitch of at least 15 cm and less than or equal to 50 cm. In another implementation, detents 64 have a center to center pitch of less than or equal to 35 cm. In yet other implementations where releasable connection to strap 30 is facilitated in other fashions, detents 64 may be omitted.

Cross brace 52 comprise a member extending between and interconnecting arms 50. FIGS. 8 and 9 illustrate cross brace 52 in more detail. In the example illustrated, cross brace 52 has a concave profile 70 which is to face the tree 22 when strap 30 wraps about tree 22. In the example illustrated, the concave profile 70 is curved or rounded, approximating the curved or rounded diameter of tree 22. Concave profile 70 facilitates positioning of extension 26 into closer proximity with the sides of tree 22.

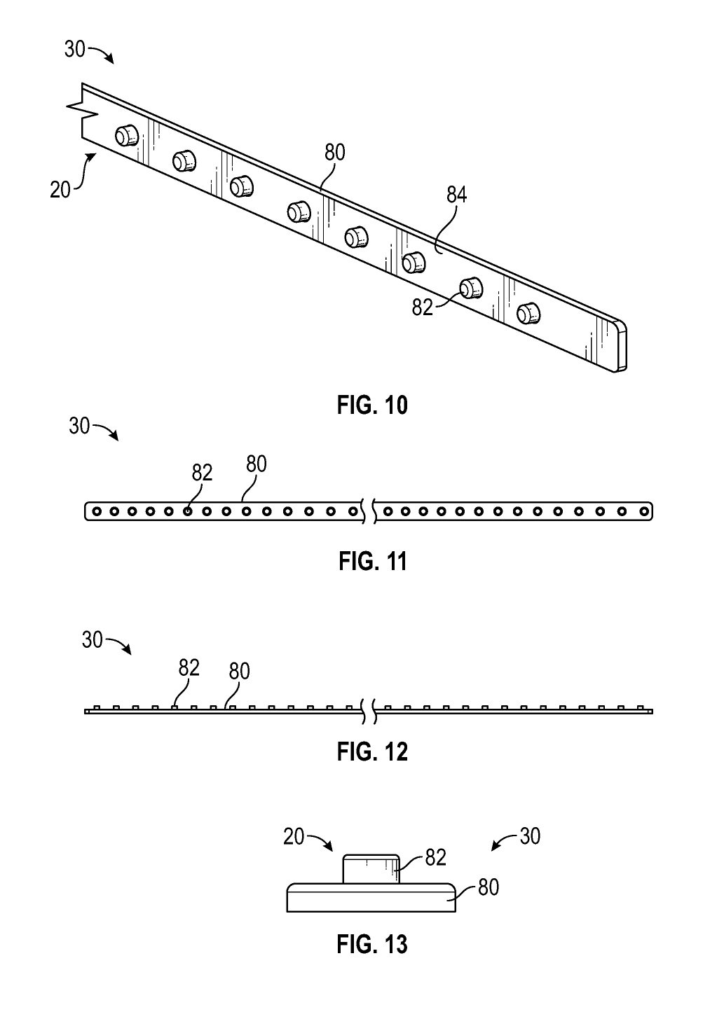

FIGS. 10-13 illustrate imperforate strap 30 in more detail. As shown by such figures, imperforate strap 30 comprises an elongate flat band 80 and a series of protuberances 82 projecting from a face 84 of band 80. In one implementation, band 80 has a thickness of less than or equal to 15 cm and a length of at least 1000 cm. In one implementation, the thickness and width of band 80 as well as its shape is such that band 80 may be slidably received within the interior 56 of the tubular structures forming arms 50. In one implementation, band 80 comprises a metal such as aluminum. In another implementation, band 80 comprises spring steel. In implementations where band 80 comprises spring steel, strap 30 is spring biased or resiliently biased such that protuberances 84 press outwardly, towards detents 64 of the arms 50 receiving the end portions of strap 30. Because band 30 is formed from a metal, band 30 is less prone to drying out, cracking, where or the like. Band 30 is also more durable and maybe more easily fabricated as compared to rubber belts. In other implementations, band 30 may be formed from a rubber material, a polymer material or other materials

Protuberances 82 are arranged in a series along band 80 on face 84. Protuberances 82 are sized, shaped and located so as to be receivable within detents 64. In one implementation, protuberances 82 have heights so as to be completely received within detents 64, allowing face 84 of band 80 to contact or abut the side face of the interior 56 of arms 50. In one implementation protuberances 82 have a height of less than or equal to 6 cm. In one implementation, protuberances 82 are welded to face 84 of band 80, wherein band 80 itself, prior to the mounting of protuberances 82, is imperforate. In such implementations, the welded protuberances 84 further strengthen strap 30. In yet other implementations, protuberances 82 may be joined to band 80 in other fashions. For example, in some implementations, protuberances 82 may project through openings in band 80, substantially or completely filling such openings in band 80 such that strap 30, as a completed structure, is imperforate.

In the example illustrated, strap 30 comprises at least five protuberances 82. In one implementation, protuberances 82 have a center to center pitch which corresponds to the center to center pitch of detents 64. In one implementation, protuberances 82 have a center to center pitch of at least 15 cm and less than or equal to 50 cm. In another implementation, protuberances 82 have a center to center pitch of less than or equal to 35 cm. In yet other implementations where releasable connection to strap 30 is facilitated in other fashions, protuberances 82 may be omitted. Although illustrated as cylindrical bosses, in other implementations, protuberances 82 may have other sizes, shapes and configurations.

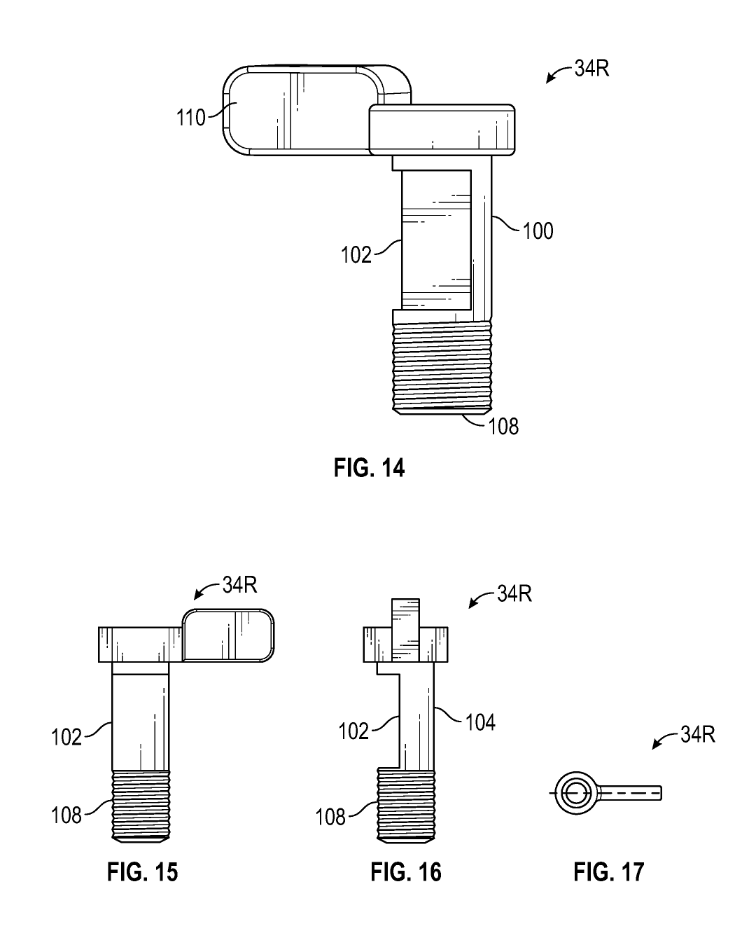

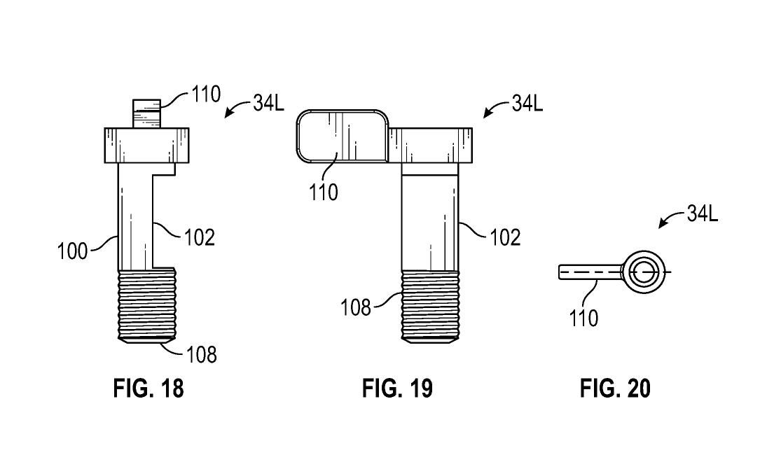

FIGS. 14-17 illustrates an example right connector 34R. FIGS. 18-20 illustrate an example left connector 34L. Connectors 34R and 34L are substantially identical to one another except that such connectors have oppositely oriented notches. Each of such connectors 34 is supported by one of arms 50. In the example illustrated, each of such connectors 34 is received within connector aperture 60 (shown in FIG. 7) of each arm 50. Each of connectors 34 comprise a cam mechanism which includes an outer circumferential camming surface 100 and an opposite cutout or notch 102. In the example illustrated, each of connector 34 further comprises a threaded end portion 108 and a lever 110.

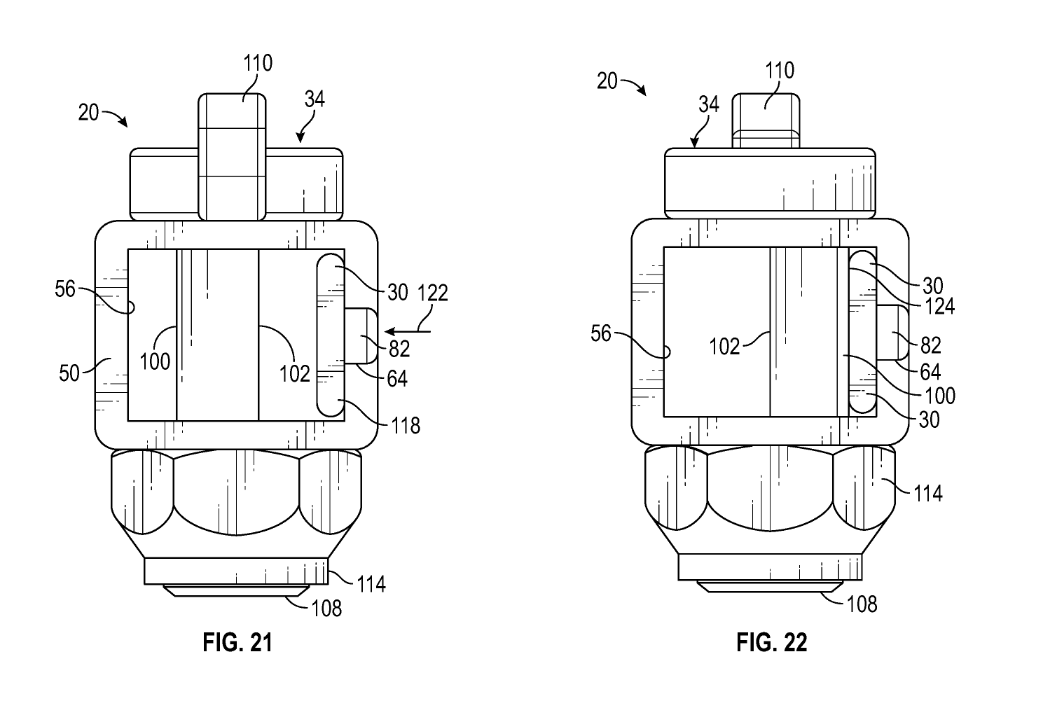

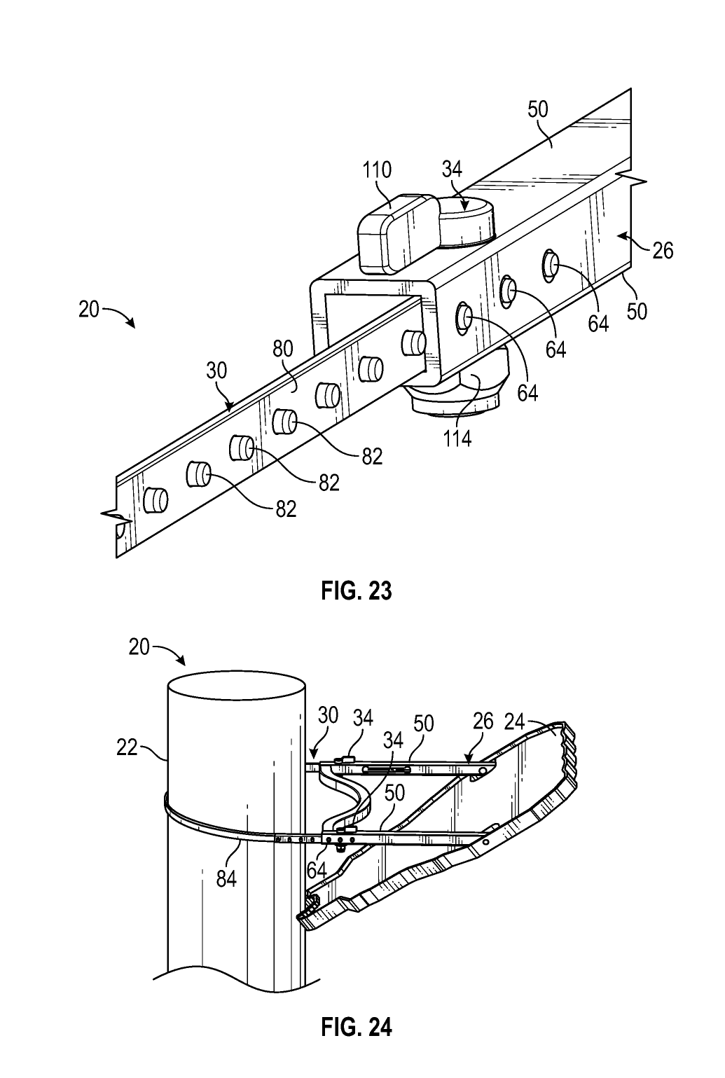

FIGS. 21-23 illustrate securement of one of connectors 34 to one of arms 50 and further illustrate the connector 34 in an open state and a locked state. As shown by such figures, each of connectors 34 passes through openings 60 and is retained by nut 114 secured to threaded portion 108. Nut 114 extends on a first bottom side of arm 50 while lever 110 extends on a top face are side of arm 50. As shown by FIGS. 21 and 22, cam surface 100 and notch 102 are located such that strap 30 is sandwiched between either cam surface 100 or notch 102 and the interior side 118 of interior 56 of arm 50. In the example illustrated, connector 34 is rotatable to an open position shown in FIG. 21, wherein notch 102 faces strap 30, allowing strap 30 to move inwardly, in the direction indicated by arrow 122, and to be received within notch 102, facilitating withdrawal of protuberances 82 from detents 64. As shown by FIG. 22, connector 34 is rotatable to a locked position in which notch 102 faces away from strap 30 and in which the cam surface 100 faces and presses against the back face 124 of strap 30 to urge and retain protuberances 82 within their corresponding detents 64. In the example where strap 30 comprise spring steel, strap 30 is resiliently biased such that protuberances 82 are resiliently biased into detents 64 even when connector 34 is in the open state shown in FIG. 21. However, the resilient spring force of strap 30 may be overcome to allow strap 30 to be extended or retracted with respect to arm 50.

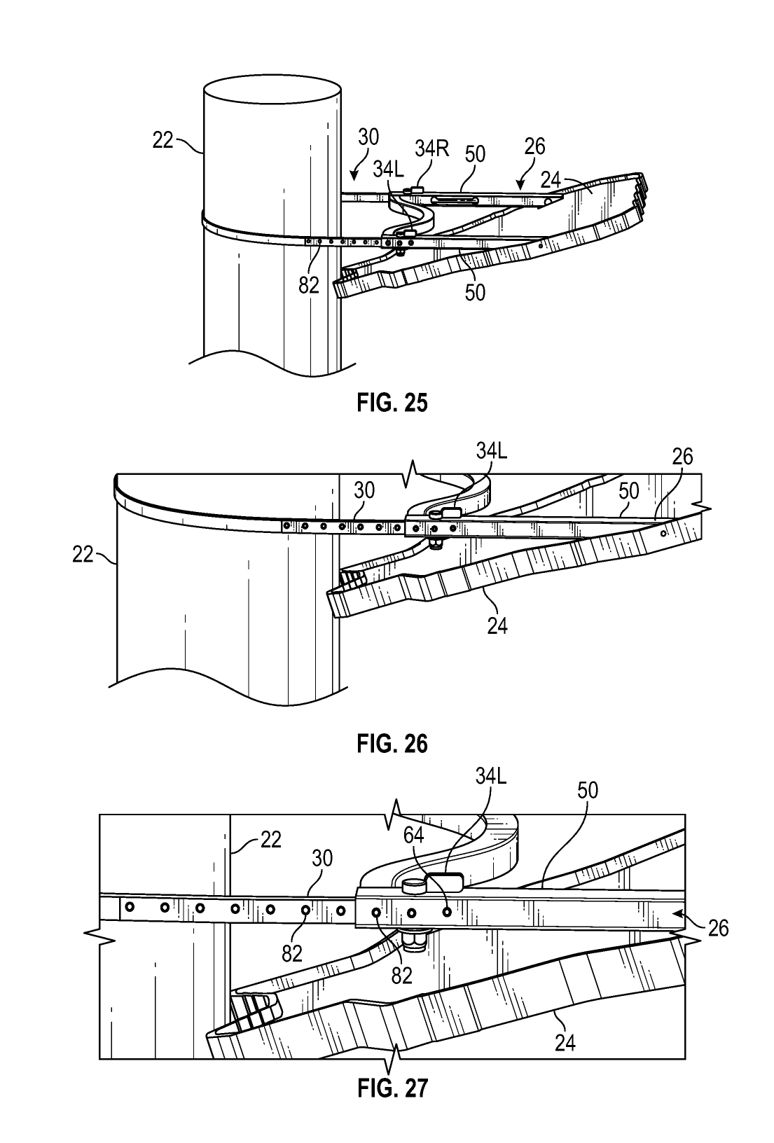

FIGS. 24-27 illustrate one example employment of tree stand 20. FIGS. 24-27 illustrate various positions of platform 20 during such deployment. In each of the views, connector 34 illustrated in the locked states. To vary the extent to which strap 30 is received within arms 50, and thereby adjust the position and orientation of platform 24 relative to tree 22, connector 34 may be temporarily moved to the unlocked position or state, allowing strap 30 to be manually pressed against the spring force and to be slid within tubes 50 to align different sets of protuberances 82 with the detents 64 of the arms 50. Once in a desired length, connector 34 once again moved (rotated) to the locked state or position.

The Figures illustrate but one example of tree stand 20. In other implementations, tree stand 20 may utilize other configurations for the imperforate strap 30. In each of such implementations, strap 30 is imperforate. For example, in other implementations, strap 30 may omit protuberances 82, but may instead comprise a series of detents or notches extending into the edge (the minor dimension) of band 80. In such an implementation, each of connectors 34 may additionally or alternatively comprise a radially extending pin or projection that is movable into and out of one of the detents or notches in the edge of band 80. In one implementation, the radially extending pin or projection is rotatable into (a locked position) and out of (and unlocked position) a selected one of the notches or detents in the edge of band 80.

Although the present disclosure has been described with reference to example implementations, workers skilled in the art will recognize that changes may be made in form and detail without departing from the spirit and scope of the claimed subject matter. For example, although different example implementations may have been described as including one or more features providing one or more benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements.

What is claimed is:

1. A tree stand comprising:
a platform having a tree gripping portion;
a support extension extending from the platform;
an imperforate strap connected to the support extension so as to wrap about a tree.

2. The tree stand of claim 1, wherein the support extension is pivotably connected to the platform.

3. The tree stand of claim 1 further comprising struts extending between and connected to the support extension and the platform.

4. The tree stand of claim 1, wherein the imperforate strap comprises spring steel.

5. The tree stand of claim 1, wherein the support extension removably receives end portions of the imperforate strap.

6. The tree stand of claim 1, wherein the support extension comprises a series of spaced detents and wherein the imperforate strap comprises a series of spaced protuberances facing the series of spaced detents.

7. The tree stand of claim 6 further comprising a cam mechanism movable between a first position in which at least one of the spaced protuberances is locked in at least one of the series of spaced detents and a second position in which all of the protuberances may be withdrawn from the series of spaced detents.

8. The tree stand of claim 7, wherein the cam mechanism is rotatable between the first position and the second position about an axis parallel to a face of the imperforate strap.

9. The tree stand of claim 8, wherein the cam mechanism comprises a shaft having a rounded portion on a first side and notch on a second side opposite the first side.

10. The tree stand of claim 6, wherein the support extension comprises:
a first tube receiving a first end portion of the imperforate strap, wherein the series spaced detents comprise a first series of apertures extending through an outwardly facing wall of the first tube;
a second tube receiving a second end portion of the imperforate strap, wherein the series of spaced at times further comprises a second series of apertures extending through an outwardly facing wall of the second tube.

11. The tree stand of claim 6, wherein the series of spaced protuberances comprises at least five spaced protuberances.

12. The tree stand of claim 6, wherein the series of spaced detents comprise at least three spaced detents.

13. The tree stand of claim 6, wherein the series of spaced protuberances have a center to center pitch of at least 15 cm and less than or equal to 50 cm.

14. The tree stand of claim 6, wherein the series of spaced protuberances have a center to center pitch of less than or equal to 35 cm.

15. The tree stand of claim 6, wherein each of the space protuberances projects at least 2 cm from a face of the imperforate strap.

16. The tree stand of claim 1, wherein the support extension comprises:
a first tubular arm releasably connected to a first end portion of the imperforate strap;
a second tubular arm releasably connected to a second end portion of the imperforate strap; and
a cross brace extending between and connected to the first tubular arm and the second tubular arm.

17. The tree stand of claim 16, wherein the cross brace has a concave profile to face the tree about which the imperforate strap is to wrap.

18. The tree stand of claim 1, wherein the imperforate strap is formed from aluminum.
